(19) United States
(12) Patent Application Publication
(10) Pub. No.: US 2017/0217245 A1
(43) Pub. Date: Aug. 3, 2017

(54) DRAWING INSTRUMENT HOLDER

(71) Applicant: Matthew DAMMAN, Bloomfield Hills, MI (US)

(72) Inventor: Matthew DAMMAN, Bloomfield Hills, MI (US)

(21) Appl. No.: 15/420,569

(22) Filed: Jan. 31, 2017

Related U.S. Application Data
(60) Provisional application No. 62/289,398, filed on Feb. 1, 2016.

(51) Int. Cl. B43K 23/016; B43K 31/00

(52) U.S. Cl. CPC B43K 23/016; B43K 31/00

(57) ABSTRACT

A multi-piece chalk holder assembly enables a user to stand up on an underlying surface while holding a piece of chalk and drawing on the underlying surface. The assembly includes a first piece that is connected to a second piece via an interference fit. The second piece is connected to a third piece via an interference fit. The first, second and third pieces are coaxial when connected via the interference fits. The third piece includes a hollow interior with a deformable material, such as foam, disposed therein. The foam is ring-shaped with an interior diameter sized to receive a piece of chalk. The foam provides a compression fit against the chalk, providing enough strength to allow the user to press the chalk against the underlying surface while drawing, while still providing interchangeability so that the user can remove and replace the piece of chalk with another piece of chalk.

### CROSS-REFERENCE TO RELATED APPLICATIONS

This application claims the benefit of U.S. provisional application Ser. No. 62/289,398 filed Feb. 1, 2016, the disclosure of which is hereby incorporated in its entirety by reference herein.

### TECHNICAL FIELD

The present disclosure relates to an elongated holder for holding drawing instruments, such as chalk.

### SUMMARY

According to another embodiment, a connectable, multi-piece chalk holder assembly for holding and supporting a stick of chalk is provided. The assembly includes a first piece having a first generally cylindrical body, a first open mouth at one end, and a first tapered region leading from the first generally cylindrical body to the first open mouth. A second piece has a second generally cylindrical body sized to be received within the first open mouth, a second open mouth at one end, and a second tapered region leading from the second generally cylindrical body to the second open mouth. A third piece has a generally cylindrical tip sized to be received within the second open mouth, a third generally cylindrical body having an open end region, and a third tapered region leading from the tip to the third body. A deformable member is disposed within the open end region and has an inner diameter sized to receive a stick of chalk.

According to yet another embodiment, a chalk holder for enabling a user to draw on an underlying surface is provided. The chalk holder includes a plurality of attachable and detachable pieces, one of the pieces having a hollow interior surface. A deformable material contacts the interior surface and is disposed radially inward from the interior surface. The deformable material has a hollow interior surface. A chalk stick is supported within the hollow interior surface of the deformable material.

According to one embodiment, an elongated drawing instrument has an outer shell made up of a top section, a middle section, and a bottom section. The top section has a generally cylindrical body a tapered region, and generally cylindrical mouth that has an inner diameter that exceeds that of the body. The mouth receives a generally cylindrical body portion of the middle section with an interference fit. The middle section also includes a tapered region and a generally cylindrical mouth at an opposite end from the top section. The mouth of the middle section receives a portion of the bottom section with an interference fit. The bottom section has an interior surface that defines a hallow cavity that includes an annular-shaped deformable member mounted therein. The deformable member has an inner radius sized to receive a piece of chalk 11, and an outer radius that is attached to the interior surface of the bottom section. The bottom section also includes an elongated opening having a length extending along the length of the bottom section to provide access to the interior of the drawing instrument, enabling a user to reach within the drawing instrument, and remove a piece of chalk by grasping the chalk and pulling it through the deformable member in a direction toward the top section.

### BRIEF DESCRIPTION OF THE DRAWINGS

FIG. 1 is a front perspective view of an elongated drawing instrument holder, according to one embodiment.

FIG. 2 is a rear perspective view of the elongated drawing instrument holder of FIG. 1.

FIG. 3 is a front view of the elongated drawing instrument holder of FIG. 1.

FIG. 4 is a rear view of the elongated drawing instrument holder of FIG. 1.

FIG. 5 is a side view of the elongated drawing instrument holder of FIG. 1.

FIG. 6 is a top view of the elongated drawing instrument holder of FIG. 1.

FIG. 7 is a bottom view of the elongated drawing instrument holder of FIG. 1.

FIG. 8 includes varies views and dimensions of parts of the elongated drawing instrument holder of FIG. 1, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

With reference to the Figures, an elongated drawing instrument holder 10 is illustrated. The drawing instrument holder 10 is a holder that is configured to hold drawings instruments such as chalk, markers, pens, pencils, paint brushes, etc. In the embodiments illustrated in these Figures, the drawing instrument that is held is a piece of chalk 11. As will be described, the drawing instrument holder 10 includes three main pieces that mechanically assemble to provide an elongated drawing instrument. For brevity, references below to the elongated drawing instrument holder 10 will be referred to as a chalk holder 10, although it should be understood that the chalk holder 10 does not necessarily have to hold chalk, and can be elongated or shortened to different dimensions than that shown in the Figures.

The chalk holder 10 can comprise three separate sections, namely, a top section 12, a middle section 14, and a bottom section 16. In one embodiment, the top section 12 and the middle section 14 are identical in size and shape, except that the top section 12 includes a cap 50 (described below). The sections 12, 14, 16 can each include an outer shell 17 that is made of polyurethane, such as a thermoplastic polyurethane. The outer shell 17 is cylindrical in substantial portions of the chalk holder 10 with a hollow center.

The sections 12, 14, and 16 can engage one another with mechanical interference fits. For example, the top section 12 is generally cylindrical, but ends in an integrally-formed mouth portion 18 that has an opening that is wider than interior of the top section 12. In other words, the majority of the top section 12 is generally cylindrical, but also includes a tapered region that leads to a mouth portion 18 that is wider than the remainder of the top section 12. The mouth portion 18 is wider than the cylindrical body such that it can receive a cylindrical body of the middle section 14. The tolerance between the mouth portion 18 and the received cylindrical body of the middle section 14 is minimal to enable a proper interference fit between the top section 12 and the middle section 14. At the other end of the middle section 14, opposite to the top section 12, is another integrally-formed mouth portion 20. This mouth portion 20 is also sized to receive a portion or rod of the bottom section 16 with a similar interference fit. The interference fits amongst the top, middle, and bottom sections 12, 14 and 16 enable a user, such as a child, to quickly and easily assemble the sections together to create a single elongated chalk holder 10.

In one embodiment, the outer diameter of the cylindrical regions of the middle section 20 and the outer diameter of the cylindrical region of the bottom section 16 (that fits within the mouth 20) are all substantially similar, while the inner diameters of the mouths 18, 20 are slightly larger to provide the interference fit.

The bottom section 16 includes a generally cylindrical region or tip (not shown) disposed within the mouth 20, a tapered region 22, and a generally cylindrical region 24 that is wider than the cylindrical region (not shown) disposed within the mouth 20. The cylindrical region 24 ends at an end region 26 such that the outer shell 17 defines an annular or circular end surface 28.

The cylindrical region 24 also defines an access port or opening 32 which provides access to the inner surface of the cylindrical region 24. As will be described below, the opening 32 allows the user to remove chalk 11 from the bottom section 16 by grasping the chalk and pulling it out through the opening 32. In one embodiment, the opening 32 has a length extending parallel to the central axis of the chalk holder 10, and a corresponding width that extends circumferentially about the cylindrical region 24 of the bottom section 16. The boundary of the opening 32 can be oval, rectangular, or the like to maintain the length and width in the aforementioned directions. This allows access for a hand of the user coming from above the chalk holder 10 when the chalk holder 10 is in a vertical orientation with respect to the underlying surface.

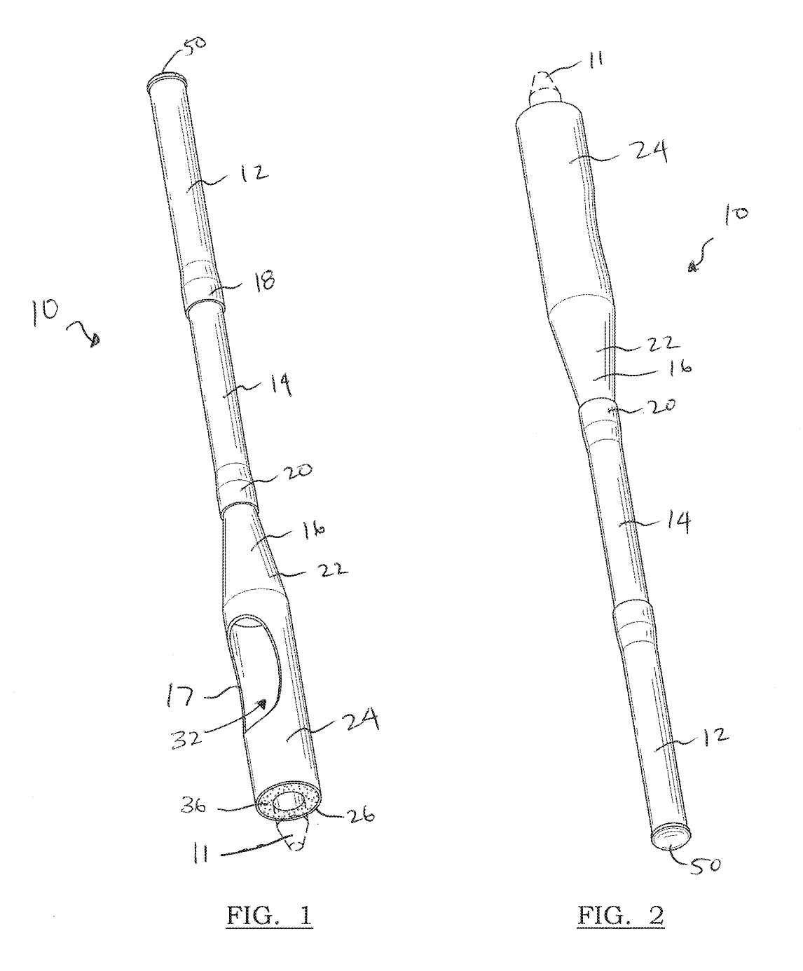

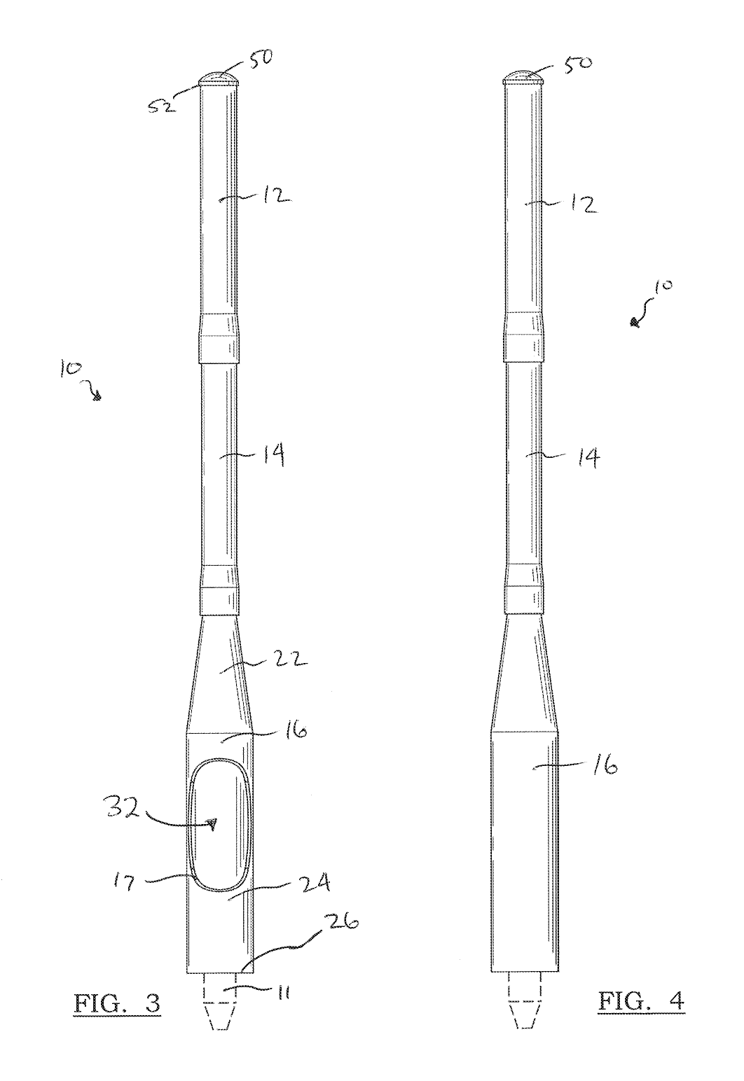

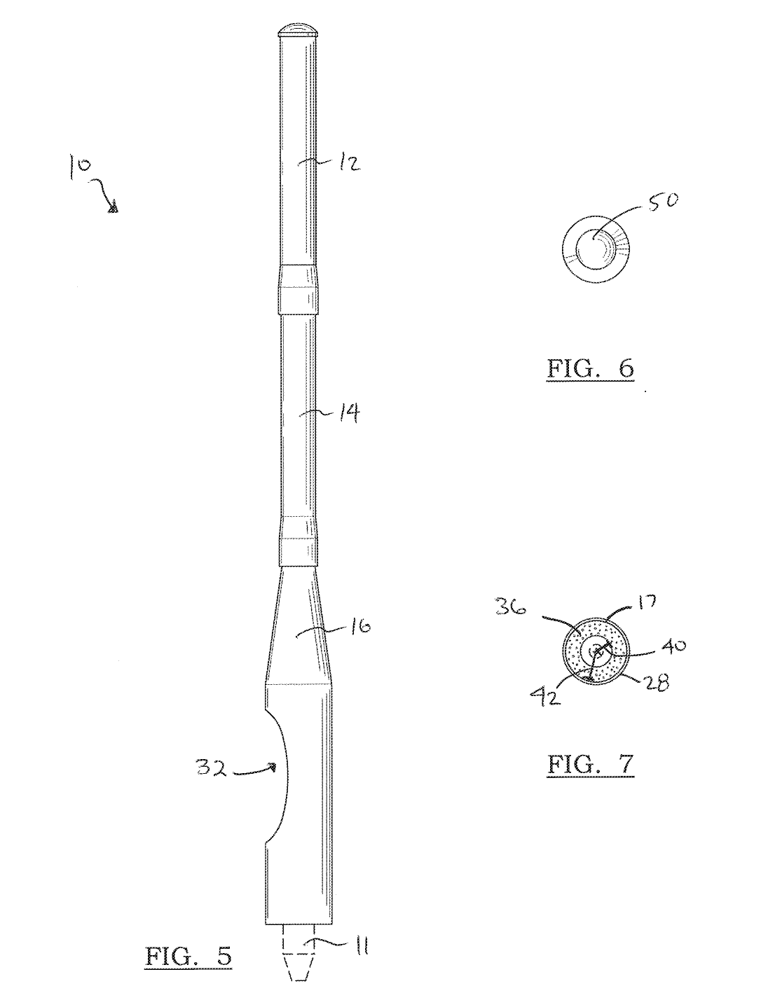

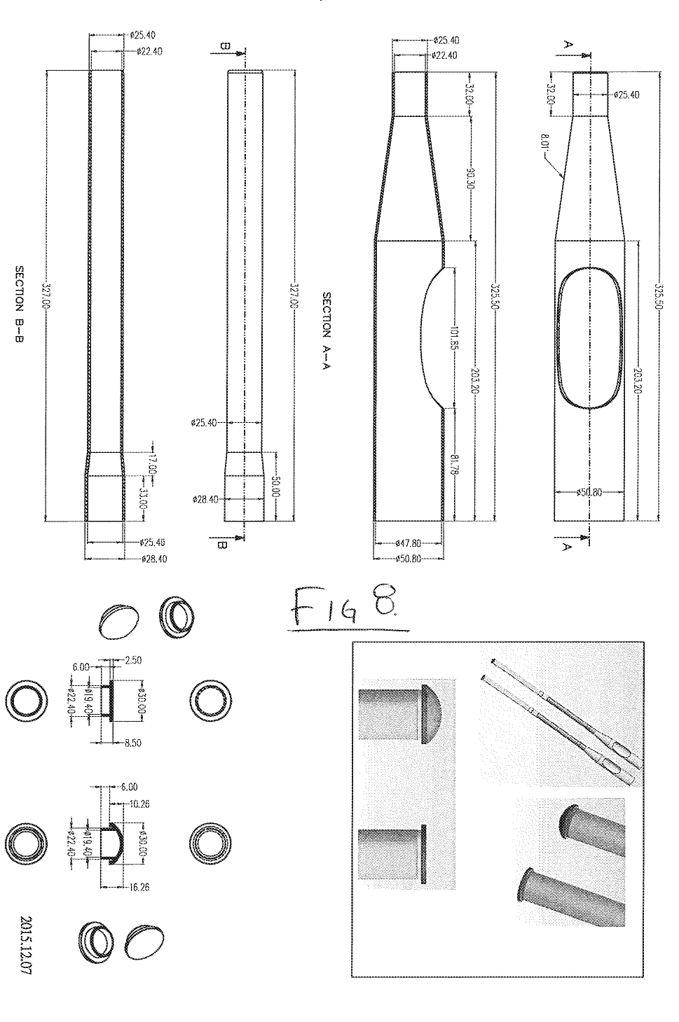

As seen in FIGS. 1 and 7, the chalk holder 10 can include a deformable material 36 adhered or otherwise secured within the interior of the outer shell of the bottom section 16. The deformable material may have an unbiased or normal outer diameter that exceeds the inner diameter of the cylindrical region 24, but is compressed or deformed to fit within the cylindrical region 24. The deformable material is annular- or donut-shaped and includes a central recess or opening 38 configured to receive a stick of chalk 11. The opening 38 may have a unbiased or normal diameter that is less than the outer diameter of the stick of chalk 11, but is compressed or deformed to widen when chalk 11 is inserted therein.

In one embodiment, the deformable material 36 is a high-density, closed-cell polyethylene foam with, for example, a density of approximately 2.5 pounds per cubic foot. One example of such a deformable material 36 is found in common pool noodles. These types of foams have been realized to provide optimum pressure on a stick of chalk to provide an adequate reaction force against the chalk to hold the chalk in place while the chalk is writing on the underlying surface, while still allowing the user to easily slide the chalk out of engagement with the foam and remove the chalk through the opening 32.

The deformable material 36 has an inner radius 40 for engaging and holding the piece of chalk 11, and an outer radius 42 for engaging the interior surface of the outer shell of the bottom portion 16. In one embodiment, the inner radius is 20 millimeters and the outer radius is 35 millimeters, yielding a thickness of 15 millimeters of foam in any one radial direction. The inner radius being 20 millimeters provides adequate frictional engagement with a standard 1-inch (25.4 millimeter) diameter stick of sidewalk chalk.

According to one embodiment, the outer shell has a thickness of 3 millimeters. Using the foam described above, a foam-to-shell thickness ratio of 5:1 is provided along any one radial direction from the center point outward. The foam-to-shell ratio may be in the range of 4:1 to 6:1.

The chalk holder 10 can also be provided with a cap 50 at the end of the top section 12. The cap 50 can have a rounded outer surface. Alternatively, the cap can have a flat outer surface. With either design, the cap 50 can have a flange 52 that extends beyond the outer diameter of the top section 12 to provide a gripping area for the user. The cap 50 can be a separate part that frictionally engages the top section 12, or mechanically adheres or fastens to the top section 12 by a separate adherent or fastener. Alternatively, the cap can be integrally formed with the top section 12.

The chalk holder 10 according to this description provides the user with the ability to use sidewalk chalk while standing. This can alleviate problems of aches and pains that accompany bending, crouching, kneeling, and crawling on cement to use sidewalk chalk to draw and write on the underlying sidewalk.

It should be understood that references to direction (e.g., “top,” “middle,” “bottom”) are for illustrative purposes only and refer to when the chalk holder is oriented as shown in FIG. 1. Of course, when the chalk holder is disassembled, the parts can be rearranged or packaged such that the top piece is not located at the “top” with respect to the remaining pieces.

In one embodiment not shown in the Figures, the top, middle, and bottom sections are integrally formed as one piece.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A connectable, multi-piece chalk holder assembly for holding and supporting a stick of chalk, the chalk holder assembly comprising:
a first piece having a first generally cylindrical body, a first open mouth at one end, and a first tapered region leading from the first generally cylindrical body to the first open mouth;
a second piece having a second generally cylindrical body sized to be received within the first open mouth, a second open mouth at one end, and a second tapered region leading from the second generally cylindrical body to the second open mouth;
a third piece having a generally cylindrical tip sized to be received within the second open mouth, a third generally cylindrical body having an open end region, and a third tapered region leading from the tip to the third body; and
a deformable member disposed within the open end region and having an inner diameter sized to receive a stick of chalk.

2. The chalk holder assembly of claim 1, wherein the third generally cylindrical body defines an access port to provide access to the stick of chalk from an interior of the third piece.

3. The chalk holder assembly of claim 1, wherein the second generally cylindrical body has an outer diameter and the first open mouth defines an inner diameter that is generally equivalent or slightly larger than the outer diameter to provide an interference fit.

4. The chalk holder assembly of claim 1, wherein the generally cylindrical tip has an outer diameter and the second open mouth defines an inner diameter that is generally equivalent or slightly larger than the outer diameter to provide an interference fit.

5. The chalk holder assembly of claim 1, wherein the deformable member includes foam.

6. The chalk holder assembly of claim 5, wherein the foam is a closed-cell polyethylene foam.

7. The chalk holder assembly of claim 1, wherein the first piece includes a cap at an opposite end from the first open mouth.

8. A chalk holder for enabling a user to draw on an underlying surface, the chalk holder comprising:
a plurality of attachable and detachable pieces, one of the pieces having a hollow interior surface;
a deformable material contacting the interior surface and disposed radially inward from the interior surface, the deformable material having a hollow interior surface; and
a chalk stick supported within the hollow interior surface of the deformable material.

9. The chalk holder of claim 8, wherein the deformable member includes foam.

10. The chalk holder of claim 9, wherein the foam is a closed-cell polyethylene foam.

11. The chalk holder of claim 8, wherein the attachable and detachable pieces include a first elongate piece, a second elongate piece, and a third elongated piece, the third elongate piece being the one of the pieces having a hollow interior surface.

12. The chalk holder of claim 11, wherein one of the first and second pieces includes an open mouth sized to receive the other of the first and second pieces.

13. The chalk holder of claim 11, wherein one of the second and third pieces includes an open mouth sized to receive the other of the second and third pieces.

14. The chalk holder of claim 11, wherein the second piece includes a pair of opposing open mouths at either end, each open mouth sized to receive the first piece and the third piece, respectively.

15. The chalk holder of claim 11, wherein a first mouth is provided to connect the first piece to the second piece with an interference fit, and a second mouth is provided to connect the second piece to the third piece with an interference fit.

16. The chalk holder of claim 11, wherein the third piece includes a tip, a generally cylindrical body, and a tapered region connecting the tip to the body.

17. An elongated drawing instrument, comprising:
a top section having a generally cylindrical body, a tapered region, and a generally cylindrical mouth that has an inner diameter that exceeds that of the body;
a middle section having a generally cylindrical body received within the generally cylindrical mouth of the top section with an interference fit, the middle section including a tapered region and a generally cylindrical mouth at an opposite end from the top section, and a bottom section; and
a bottom section coupled to the middle section via an interference fit, the bottom section having an interior surface that defines a hollow cavity that includes an annularly-shaped deformable member supported therein, the deformable member having an inner radius sized to receive a piece of chalk and an outer radius supported by the interior surface of the bottom section, the bottom section further including an access port defined therein to provide access to an interior of the drawing instrument and sized to enable a user to reach within the drawing instrument and remove a piece of chalk by grasping the chalk and pulling it through the deformable member in a direction toward the top section.
